(19) United States
(12) Patent Application Publication
(10) Pub. No.: US 2022/0391817 A1
(43) Pub. Date: Dec. 8, 2022

(54) Fulfilling Item Requests on an Aircraft Based on a Zoning Definition for the Aircraft

(71) Applicant: ViaSat, Inc., Carlsbad, CA (US)

(72) Inventors: ULTAN O'BRIEN, Carrickmines (IE); NIALL O'SULLIVAN, Dundrum (IE); FERGAL MURRAY, Tomhaggard (IE)

(21) Appl. No.: 17/770,286

(22) PCT Filed: Oct. 21, 2019
(86) PCT No.: PCT/US2019/057281

§ 371 Date: Apr. 19, 2022

(51) Int. Cl. G06Q 10/06; B64D 11/00; B64D 11/06

(52) U.S. Cl. CPC G06Q 10/063116; G06Q 10/06316; B64D 11/0007; B64D 11/00151; B64D 11/06; G06Q 10/0875

(57) ABSTRACT

Technology is described for processing requested items on an aircraft. A server onboard the aircraft may identify a zoning definition for the aircraft that divides aircraft seating into a plurality of service zones. The server may receive a request for an item from a client device onboard the aircraft. The request may include a delivery location within one of the service zones of the aircraft. The server may assign the request to a crew member identifier (ID) based in part on the delivery location and the zoning definition for the aircraft. The server may transmit the request to a fulfillment computing device associated with the crew member ID.

### BACKGROUND

Passengers often consume food and drink when onboard an aircraft. For example, the food and drink may be complimentary on the aircraft, or passengers may have an option to purchase the food and drink. The food and drink available to passengers may vary depending on a flight length (e.g., short-haul flight versus long-haul flight), airline company, class of travel (e.g., first class, business class, or economy class), etc. Similarly, passengers onboard and aircraft may receive or purchase other non-food items such as pillows, blankets, headphones, duty free products (e.g., perfumes, chocolates, etc.), utensils, or other items and products from the crew members or airline staff aboard the aircraft.

In some cases, passengers may obtain the food, drink or other items when a crew member or airline staff onboard the aircraft make an appointed round through the aircraft cabin to distribute food, drink or items. Passengers may also request food, drink, items or products by pushing the assistance button above the passenger's seat which typically activates a light above the passenger's head or in another location. The assistance button has been used for decades to allow passengers to make a request to a crew member or staff on an aircraft. Passengers have also been able to make a payment via crew members or airline staff by providing a credit card that can be scanned and accepted by a mobile credit card device, or passengers may often pay cash.

### SUMMARY

A method for processing requested items on an aircraft is provided. The method may include identifying, at a server onboard the aircraft, a zoning definition for the aircraft that divides aircraft seating into a plurality of service zones. The method may include receiving, at the server, a request for an item from a client device onboard the aircraft. The request may include a delivery location within one of the service zones of the aircraft. The method may include assigning, at the server, the request to a crew member identifier (ID) based in part on the delivery location and the zoning definition for the aircraft. The method may include transmitting, from the server, the request to a fulfillment computing device associated with the crew member ID.

A non-transitory machine readable storage medium having instructions embodied thereon is provided. The instructions when executed by one or more processors, cause the one or more processors to perform a process. The process may include receiving, at the server, a request for an item from a client device onboard the aircraft. The request may include a delivery location within a service zone included in a plurality of service zones of the aircraft. The process may include adding, at the server, the request to queue of requests to be fulfilled. The process may include assigning, at the server, the request to a crew member identifier (ID) based in part on the delivery location and a zoning definition for the aircraft. The process may include transmitting, from the server, the request to a fulfillment computing device associated with the crew member ID. The process may include receiving a notification from the fulfillment computing device after the request has been fulfilled at the delivery location within the aircraft. The process may include removing the request from the queue of requests.

A system is provided that may include at least one processor and at least one memory device including a data store to store a plurality of data and instructions. The plurality of data and instructions, when executed, cause the system to identify a zoning definition for an aircraft that divides aircraft seating into a plurality of service zones. The zoning definition may assign one or more crew member identifiers (IDs) to each of the service zones. The plurality of data and instructions, when executed, cause the system to receive a request for an item from a first application that executes on a client device. The request may include a delivery location within one of the service zones of the aircraft. The plurality of data and instructions, when executed, cause the system to identify a crew member ID associated with a service zone in the plurality of service zones that includes the delivery location in accordance with the zoning definition. The plurality of data and instructions, when executed, cause the system to transmit the request to a second application that executes on a fulfillment computing device associated with the crew member ID.

### BRIEF DESCRIPTION OF THE DRAWINGS

FIG. 1 illustrates a system for processing item requests on an aircraft according to an example of the present technology.

FIG. 2 illustrates another system for processing item requests on an aircraft according to an example of the present technology.

FIG. 3 illustrates a system for reassigning item requests on an aircraft according to an example of the present technology.

FIG. 4 illustrates a system for maintaining an inventory of available items on an aircraft according to an example of the present technology.

FIG. 5 illustrates a system for assigning item requests on an aircraft according to an example of the present technology.

FIG. 6 illustrates a zoning definition for an aircraft according to an example of the present technology.

FIG. 7 illustrates another zoning definition for an aircraft according to an example of the present technology.

FIG. 8 illustrates a passenger interface for an application that executes on a client device according to an example of the present technology.

FIG. 9 illustrates a crew interface for an application that executes on a fulfillment computing device according to an example of the present technology.

FIG. 10 is a flowchart of an example method for processing requested items on an aircraft.

FIG. 11 is a flowchart of another example method for processing requested items on an aircraft.

FIG. 12 is a satellite communication system according to an example of the present technology.

FIG. 13 is a block diagram that provides an example illustration of a computing device that may be employed in the present technology.

### DETAILED DESCRIPTION

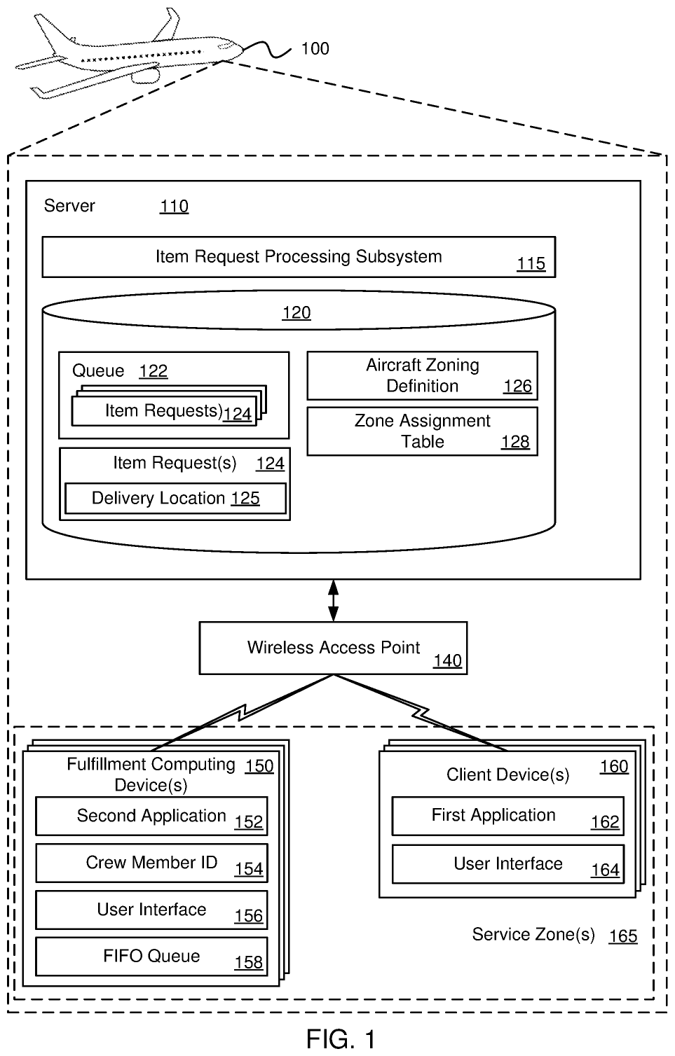

FIG. 1 illustrates an example of a system for processing item requests 124 using a server 110 onboard an aircraft 100. In examples described herein, the system for processing item requests 124 using the server 110 is described in the context of the aircraft 100. Alternatively, the system and server 110 may be used in other types of multi-passenger vehicles such as trains, cruise ships, etc. The server 110 may include an item request processing subsystem 115 for receiving item request(s) 124 from client device(s) 160 located within the aircraft 100, and sending the item request(s) 124 to selected fulfillment computing device(s) 150 located within the aircraft 100 for fulfillment. In this example, the client devices 160 may be personal electronic devices, such as mobile phones or tablet computers.

In one example, the item requests 124 may be processed by the item request processing subsystem 115 on a first-come, first-serve basis or in another order that is pre-determined. An item request 124 may be for an item requested, purchased or ordered by a passenger onboard the aircraft 100 via the client devices 160. Non-limiting examples of items that may be available for request or purchase include food, drinks or beverages, such as water. Other items for request or purchase may include pillows, blanket, headphones, duty free items, products, amenities, etc.

In one example, the server 110 may communicate with the client device(s) 160 and the fulfillment computing device(s) 150 via a wireless access point 140 onboard the aircraft 100. A wireless connection between the server 110 and the client device(s) 160 and the fulfillment computing device(s) 150 may be established using Transmission Control Protocol/Internet Protocol (TCP/IP), and services in the server 110 may be web services that are RESTful. The wireless access point 140 may operate using a W-Fi protocol, a Bluetooth protocol or another appropriate wireless protocol. In other examples, the server 110 may communicate with the client device(s) 160 and/or the fulfillment computing device(s) via a wired connection.

In one configuration, a client device 160 may execute a first application 162, such as an ordering application. As an example, the first application 162 may provide a user interface 164 that enables a passenger to view an electronic menu of items that may be requested by the passenger. These items may include food and/or drink items that are available for free and/or purchase on the aircraft 100. The electronic menu may be sent from the server 110 to the first application 162 executing on the client device 160. Thus, the server 110 on the aircraft 100 may communicate information, such as the electronic menu, to the client device(s) 160 using a wired or wireless network onboard the aircraft. The passenger may electronically place an item request 124 via the user interface 164, where the item request 124 may be for a food item, drink item, etc. and a requested quantity for each item. The passenger may, if needed, also enter payment details, such as credit card or other electronic payment systems (e.g., PayPal, Venmo, debit cards, or similar systems) while making the item request 124. The item request 124 may include a delivery location 125 (e.g., a specific seat number, multiple seat numbers or a set of seat numbers which may include contiguous or non-contiguous seat numbers). After the passenger enters pertinent information for the item request 124, the first application 162 may send the item request 124 to the server 110. The manner in which the delivery location 125 is associated with the item request 125 can vary from example to example. In some examples, the passenger may enter the delivery location 125 (or delivery locations 125 for different items that are part of the same item request 125) via the user interface 164. In other examples, the client device 160 used by the passenger to place the item request 124, and/or the passenger placing the request, may already be associated with the delivery location 125. For example, the passenger may enter identifying information via the user interface 164, and the delivery location 125 may be the seat number of the passenger to be retrieved from a passenger manifest file.

The item request processing subsystem 115 may receive the item request 124. The item request processing subsystem 115 may add the item request 124 to a queue 122 stored on a data store 120 of the server 110. The queue 122 may be a listing of outstanding item requests 124 for the aircraft 100. The queue 122 may be, but is not limited to, a FIFO queue, a priority queue, a ring buffer, a stack, a double-ended queue or a multi-ended queue. The queue 122 may be used to assign the item request(s) 124 to the fulfillment computing devices 150, after which the item request(s) 124 may leave the queue 122.

In one example, the item requests 124 (or an indication of the item requests 124) may be placed into the queue 122 when the item requests 124 are to be assigned, and the item requests 124 may also be stored as records in the data store 120 outside the queue 122. The records of the item requests 124 may be maintained by the server 110 and may be updated in response to notifications from the fulfillment computing device 150 when events related to the item request 124 occur (e.g., acceptance of an order, reassignment, cancellation, completion, etc.). Alternatively, the queue 122 may only include unique identifiers (e.g., numerical or symbolic reference, an address pointer, etc.) of the item requests 124.

The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

In one example, after item request(s) 124 are assigned out to fulfillment computing devices 150 by the item request processing system 115, the server 110 may track a status (e.g., pending, completed, cancelled, etc.) of the item request 124 that has been assigned and to which fulfillment computing device 150 (or crew member ID 154) the item request 124 has been assigned. For example, once an item request 124 is completed by a crew member, the crew member may indicate that the item request 124 has been completed in the second application 152 executing on the fulfillment computing device 150, and the second application 152 may send an indication of fulfillment to the server 110. The server 110 may then update the status of the order to reflect completion of the item request 124. In addition, the server 110 may perform a similar process to track orders that have been reassigned to another fulfillment computing device 150.

In one example, each fulfillment computing device 150 may maintain a separate device-specific queue 158 (e.g., a FIFO queue). For example, an item request 124 may be added to a queue on the fulfillment computing device 150 when the item request 124 is assigned to the fulfillment computing device 150. After the item request 124 is fulfilled, the item request 124 may be removed from the queue 158 of pending orders on the fulfillment computing device 150, but information on completed orders may be accessible by selecting a “completed” button on the user interface 156 of the fulfillment computing device 150. In one configuration, the server 110 may not have a queue or track the fulfillment status of the item requests 124 but the queue and tracking of the fulfillment status may only be performed on the fulfillment computer device 150.

The item request processing subsystem 115 may analyze the item request 124 to identify the delivery location 125 for the item request 124. Based on the delivery location 125 and an aircraft zoning definition 126 for the aircraft 100, the item request processing subsystem 115 may identify a crew member ID 154 associated with a crew member to fulfill the item request 124 (i.e., the crew member assigned to a service zone 165 that contains the delivery location). The crew member ID 154 may be a number, value, screen name, key, or even an image (e.g., company photo) that represents the crew member. The aircraft zoning definition 126 may be stored on the data store 120, and may indicate a number of assigned service zones 165 for the aircraft 100. The aircraft zoning definition 126 divides the aircraft 100 into one or more service zones 165, where each service zone 165 may be associated with a group of seat numbers (e.g., contiguous seats or portion of rows on a side of an aisle, etc.). The aircraft zoning definition 126 may be determined prior to, during or after take-off of the aircraft 100. The aircraft zoning definition 126 may be based on entry of data by a human or using a process for automatically zoning the aircraft using zoning rules. Further, the data store 120 may include a zone assignment table 128, which may be a table of crew member IDs 154 that are assigned or linked to a given service zone 165, as indicated in the aircraft zoning definition 126. Thus, the item request processing subsystem 115 may identify the passenger's service zone 165 based on the delivery location, and then determine the crew member ID 154 (or multiple crew IDs) that is assigned to the passenger's service zone 165 based on the aircraft zoning definition 126 and the zone assignment table 128. In other words, the zone assignment table 128 may indicate one or more crew member IDs 154 (associated with one or more fulfillment computing devices 150) that are assigned to a specific service zone 165 of the aircraft 100. For example, the zone assignment table 128 may indicate that a first crew member ID is assigned to a first service zone, a second crew member ID is assigned to the first service zone, a third crew member ID is assigned to a second service zone, and so on.

As a non-limiting example, the aircraft zoning definition 126 may indicate that the aircraft 100 is divided into three service zones. A first service zone may be associated with seat rows 1 to 10, a second service zone may be associated with seat rows 11-25, and a third service zone may be associated with set rows 26-40. Further, the aircraft zoning definition 126 may indicate that one crew member ID is assigned to the first service zone (e.g., crew_ID_3), two crew members IDs are assigned to the second service zone (e.g., crew_ID_17 and crew_ID_22), and two crew member IDs are assigned to the third service zone (e.g., crew_ID_7 and crew_ID_11).

In one example, the server 110 may determine the aircraft zoning definition 126. The server 110 may determine the aircraft zoning definition 126 based on one or more of a number of seating rows on the aircraft 100, a number of decks on the aircraft 100, a number of crew members serving the aircraft 100, a travel class associated with passengers onboard the aircraft 100, a type of aircraft 100, a number of passengers onboard the aircraft 100, and/or a distribution of passengers onboard the aircraft 100. Further, the server 110 may assign one or more crew member IDs 154 to each service zone 165 defined by the aircraft zoning definition 126. The server 110 may randomly assign a particular crew member ID 154 to a particular service zone 165, or may select from a subset of crew member IDs 154 for a particular service zone 165 using defined assignment rules.

In one example, the server 110 may determine the aircraft zoning definition 126 based on an instruction received from one of the fulfillment computing devices 150 (e.g., a fulfillment computing device associated with a lead crew member). For example, the server 110 may receive an instruction that the aircraft 100 is to be divided into a specific number of service zones 165. Further, the server 110 may receive an instruction that a particular crew member ID 154 is to be associated with a particular service zone 165. In this configuration, rather than automatically determining the aircraft zoning definition 126 automatically based on the number of seating rows, the number of decks, the number of crew members, etc., the server 110 may receive at least part of a definition for the aircraft zoning definition 126 from the fulfillment computing device 150.

In other words, a service zone 165 within the aircraft 100 may be assigned to a crew member ID 154 as part of the aircraft zone assignment table 128. The crew member ID 154 may be associated with a crew member onboard the aircraft 100. The item request processing subsystem 115 may send the aircraft zoning definition 126 and the zone assignment table 128 to a fulfillment computing device 150 associated with the crew member ID 154, where the zone assignment table 128 may include an indication of service zone(s) 165 that are to be served by the crew member. Thus, based on the aircraft zoning definition 126 and the zone assignment table 128, item requests 124 that are placed by passengers within a defined service zone 165 may be fulfilled by a crew member that is allocated to that service zone 165.

In one example, the server 110 may identify multiple service zones 165 when the delivery location 125 specifies multiple delivery locations (e.g., seat numbers) in different service zones 165 of the aircraft 100. In this example, the server 110 may identify multiple crew member IDs 154 that correspond to the multiple service zones 165, using the aircraft zoning definition 126. Thus, the server 110 may assign a portion of the item request 124 to one identified crew member ID 154, and another portion of the item request 124 to another identified crew member ID 154.

In one example, the item request processing subsystem 115 may send the item request 124 to the fulfillment computing device 150 associated with the assigned crew member ID 154 via the wireless access point 140. Alternatively, the item request 124 may be sent to the fulfillment computing device 150 in other ways. The fulfillment computing device 150 may execute a second application 152. The second application 152 may provide a user interface 156 that enables a crew member to perform various functions described herein including viewing outstanding item request(s) 124 for the associated service zone 165. Further, the fulfillment computing device 150 may maintain the separate FIFO queue 158 and assigned item requests 124 may be added to the FIFO queue 158, and the item requests 124 may be removed from the FIFO queue 158 after fulfillment of the item request 124. For example, the second application 152 may provide an audio and/or visual notification for the crew member when the item request 124 is received at the fulfillment computing device 150. The crew member may also view details of the item request 124 via the user interface 156. After fulfillment of the item request 124, the crew member may indicate that the item request 124 has been fulfilled via the user interface 156, and the second application 152 may send a notification to the item request processing subsystem 115. The item request processing subsystem 115 may remove the item request 124 from the queue 122 in response to receiving the notification.

In one example, multiple crew member IDs 154 may be allocated to the one service zone 165, as part of the zoning assignment using the zone assignment table 128. In other words, multiple crew members may work together in the same service zone 165. The service zone 165 may be one service zone 165 on the aircraft or one of many service zones 165 of the aircraft 100.

In this example, when an item request 124 is received, the item request 124 may be sent to the multiple crew members based on the zoning assignments for the aircraft 100. The server 110 may transmit the item request 124 to multiple fulfillment computing devices 150 associated with the multiple crew member IDs 154. The server 110 may receive a notification when the item request 124 has been accepted by a crew member associated with one of the multiple crew member IDs 154. Alternatively, when a single service zone 165 is allocated for the aircraft 100 and an item request 124 is received, the item request 124 may be assigned to a next available crew member on the aircraft 100, irrespective of the delivery location 125 for the item request 124. The server 110 may transmit the item request 124 to a fulfillment computing device 150 associated with the next available crew member.

In one example, the server 110 may receive a first notification when the item request 124 has been accepted by the crew member. Further, the server 110 may receive a second notification when the item request 124 is fulfilled by the crew member. The second notification may be received later in time as compared to the first notification, when the physical fulfillment has been completed.

As a non-limiting example, a passenger may request or order a sandwich and drink using the first application 162. The passenger may indicate a delivery location 125 of seat 15A in the item request 124 by entering the seat location via the user interface 164. The first application 162 may send the item request 124 to the item request processing subsystem 115. The item request processing subsystem 115 may determine that the delivery location 125 of seat 15A is within service zone 2 of the aircraft 100, in accordance with the aircraft zoning definition 126. Further, the item request processing subsystem 115 may determine that service zone 2 is served by a crew member ID 154 that is “crew_member_33”, in accordance with the aircraft zoning definition 126. The item request processing subsystem 115 may send the item request 124 to the fulfillment computing device 150 associated with the crew member ID 154 of “crew_member_33”. The crew member associated with the fulfillment computing device 150 may view the item request 124 via the user interface 156 and subsequently fulfill the item request 124. For example, the crew member may physically carry out the item request 124 to the passenger (e.g., deliver food, drink, product or another item to the passenger at a delivery location 125 specified in the item request 124). Further, after the crew member delivers the item in accordance with the item request 124, the crew member may indicate (e.g., by checking a box or pressing a button) that the item request 124 has been fulfilled via the second application 152 executing on the fulfillment computing device 150.

In one configuration, a crew member may login to the second application 152 via the user interface 164 using their crew member ID 154 (and possibly other login credentials). The crew member may login prior to takeoff of the aircraft 100, or after the aircraft 100 takes off and reaches a certain altitude. The second application 152 may receive an assigned service zone for the crew member upon login. For example, the second application 152 may receive a notification that the crew member is assigned to service zone 1, which may span from seat rows 1-11. In one example, the service zone 165 may be assigned randomly for the crew member ID 154. In another example, the service zone 165 may be assigned based on a particular crew member ID 154. For example, a particular crew member ID 154 may be associated with a crew member that has a preference to serve first class passengers. In this case, the service zone 165 (e.g., service zone 1) assigned to that crew member may include first class passengers. The crew member may accept the assigned service zone via the user interface 156. Thereafter, item requests 124 with delivery locations in that service zone 165 may be received at the second application 152.

In one configuration, the passenger may download and install the first application 162 on the client device 160 prior to takeoff of the aircraft 100 or after the aircraft 100 has taken off. Similarly, the crew member may download and install the second application 152 on the fulfillment computing device 150 prior to takeoff of the aircraft 100 or after the aircraft 100 has taken off. For example, the client device 160 and the fulfillment computing device 150 may download application file(s) that are stored on the server 110, and the application file(s) may be installed, such that the first application 162 may run on the client device 160 and the second application 152 may run on the fulfillment computing device 150. In an alternative example, the first application 162 and the second application 152 may be web applications that are accessible via a browser.

In one example, the second application 152 and the first application 162 may be separate copies of the same application. When the crew member logs in to the second application 162 using the crew member ID 154 (and possibly other login credentials), the crew member may view item requests 124 to be fulfilled. When the passenger logs in to the first application 162 using a passenger ID (and possibly other login credentials) or no ID at all, the passenger may be able to place the item request 124. In other words, the passenger may login using the passenger ID, and the first application 162 may enable the passenger to electronically place the item request 124, whereas the crew member may login using the crew member ID 154, and the second application 152 may enable the crew member to fulfill the item request 124. Alternatively, the passenger may not need to login and may provide credit card payment or electronic payment and a seat number. Thus, the credit card payment or electronic payment may act as a validation or login.

Alternatively, the second application 152 and the first application 162 may be distinct applications that execute on the fulfillment computing device 150 and the client device 160, respectively. In other words, the first application 162 may facilitate placing the item request 124 and the second application 152 may facilitate fulfilling the item request 124.

In one example, the server 110 that processes the item requests 124 may be located onboard the aircraft 100. Thus, communications between the server 110, the fulfillment computing device(s) 150 and the client device(s) 160 may be performed locally via the wireless access point 140 and/or a wired connection. The communications may be performed locally to avoid requiring connection to a server on the ground.

In one example, the server 110 may notify crew members of locations on the aircraft 100 of available items, which may enable the crew members to fulfill the item request 124. As a non-limiting example, the server 110 may notify the crew members that a food item is located in a particular storage unit of the aircraft 100, pillows are located in a separate storage unit of the aircraft 100, duty free items are located in a locked cabinet, etc.

The fulfillment computing device(s) 150 and the client device(s) 160 may comprise, for example, processor-based systems. The fulfillment computing device(s) 150 and the client device(s) 160 may be devices such as, but not limited to, laptops or notebook computers, tablet computers, mobile devices, handheld computers, or other devices with like capability. The client device(s) 160 and/or the fulfillment computing device(s) 150 may be mobile computing devices. The client device(s) 160 and/or the fulfillment computing device(s) 150 may be personal electronic devices or may be property of an aircraft operator. In another example, the client device(s) 160 and the fulfillment computing device(s) 150 may be seatback systems that are installed on seats of the aircraft 100. For example, a passenger may use an interface of a seatback system that is installed on a seat in front of the passenger in order to view a menu and place an item request or order. Similarly, a crew member may use an interface of a seatback system (or another type of fixed computing device) to view outstanding item requests.

In one example, the present technology may enable passengers on an aircraft to be provided items on a first-come, first-serve basis via the first application, which can improve order efficiency and an amount of time taken for a passenger to receive an item on the aircraft. In the past, crew members on an aircraft would typically start a food/drink service at a front or end of the aircraft. Depending on a passenger's seating location (e.g., a middle or end of the aircraft), the passenger may have waited an increased amount of time to be served by the crew member as compared to passengers in other rows. Further, in the past, crew members on the aircraft would inquire about food/drink to a majority of passengers on the aircraft, irrespective of whether the passengers wanted food/drink items, thereby increasing the amount of time taken to reach passengers seated at undesirable locations within the aircraft (e.g., the middle of the aircraft). With the present technology, passengers may place requests or orders for items (e.g., food, drinks, blankets, pillows, headphones, duty free items, or amenities) from anywhere on the aircraft using the first application executing on the client device. The item requests may be processed by the crew members on the aircraft on a first-come, first-serve basis (i.e., item requests may be processed based on a time at which they are received), thereby providing a fair ordering process for all passengers on the aircraft. In other words, with the present technology, a passenger's assigned seating location (which often times is out of the passenger's control) may not dictate the timeliness at which the passenger is served.

The various processes and/or other functionality contained within the server(s) 110 may be executed on one or more processors that are in communication with one or more memory modules. The server(s) 110 may include a number of computing devices that are arranged, for example, in one or more server banks or computer banks or other arrangements.

In one configuration, the server 110 may communicate with the fulfillment computing device(s) 150 and the client device(s) 160 via a network. The network may include any useful computing network, including a localized network, a wireless data network, or any other such network or combination thereof. Components utilized for such a system may depend at least in part upon the type of network and/or environment selected. Communication over the network may be enabled by wired or wireless connections and combinations thereof.

FIG. 1 illustrates that certain processing modules or subsystems may be discussed in connection with this technology. In one example configuration, a module or subsystem may be considered a service with one or more processes executing on a server or other computer hardware. For example, modules or subsystems providing services may be considered on-demand computing that are hosted in a server. An application programming interface (API) may be provided for each module or subsystem to enable a second module or subsystem to send requests to and receive output from a first module or subsystem. Such APIs may also allow third parties to interface with the module or subsystem and make requests and receive output from the modules or subsystems.

While FIG. 1 illustrates an example of a system that may implement the techniques above, many other similar or different environments are possible. The example environments discussed and illustrated above are merely representative and not limiting.

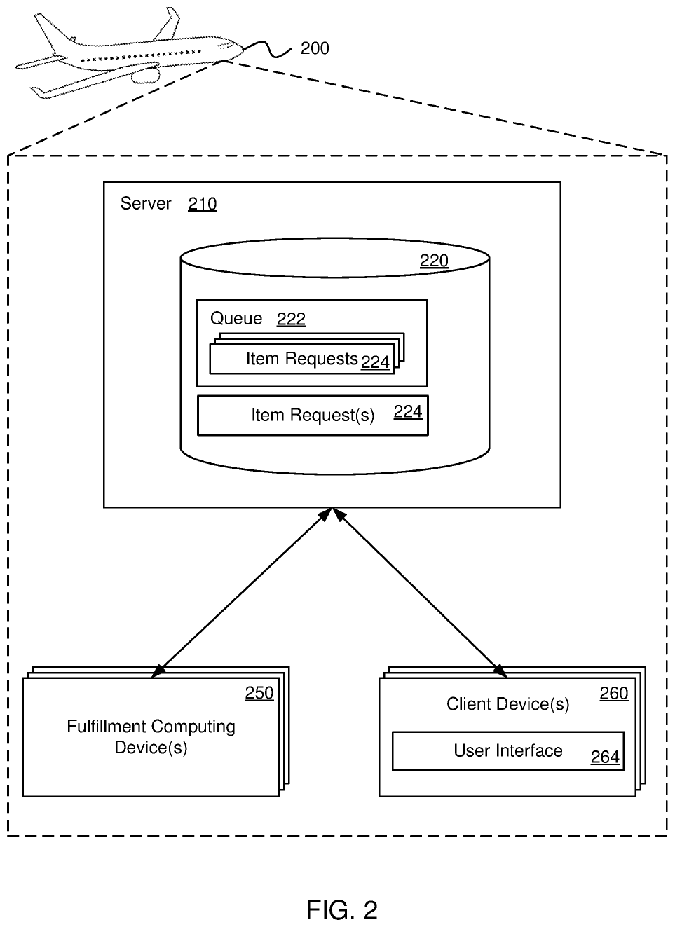

FIG. 2 illustrates an example of a system for processing item requests 224 using a server 210 onboard an aircraft 200. The server 210 may include all of the functionality of server 110, as described earlier. In this example, the item requests 224 may be received at the server 210 from a client device 260, which may be a seatback system installed on a seat in front of a passenger sitting in the aircraft 200. The item requests 224 may be included on a queue 222, which may be stored on a data store 220 of the server 210. For example, the client device 260 may transmit the item request 224 over a wired connection (or a wireless connection) between the server 210 and the client device 260 (e.g., the seatback system). The server 210 may process the item requests 224 by sending the item requests 224 to an appropriate fulfillment computing device 250. In this example, since the client device 260 is stationary, the passenger may sit behind the seat on which the client device 260 is installed to view available items and initiate item requests 224 via a user interface 264 of the client device 260. Further, the fulfillment computing devices 250 may be connected to the server 210 via a wired (or wireless) connection.

In one configuration, the fulfillment computing devices 250 may communicate with the server 210 over a wireless connection (e.g., to enable crew members to move within the aircraft 200 while carrying the fulfillment computing devices 250), and the client devices 260 may communicate with the server 210 over a wired connection.

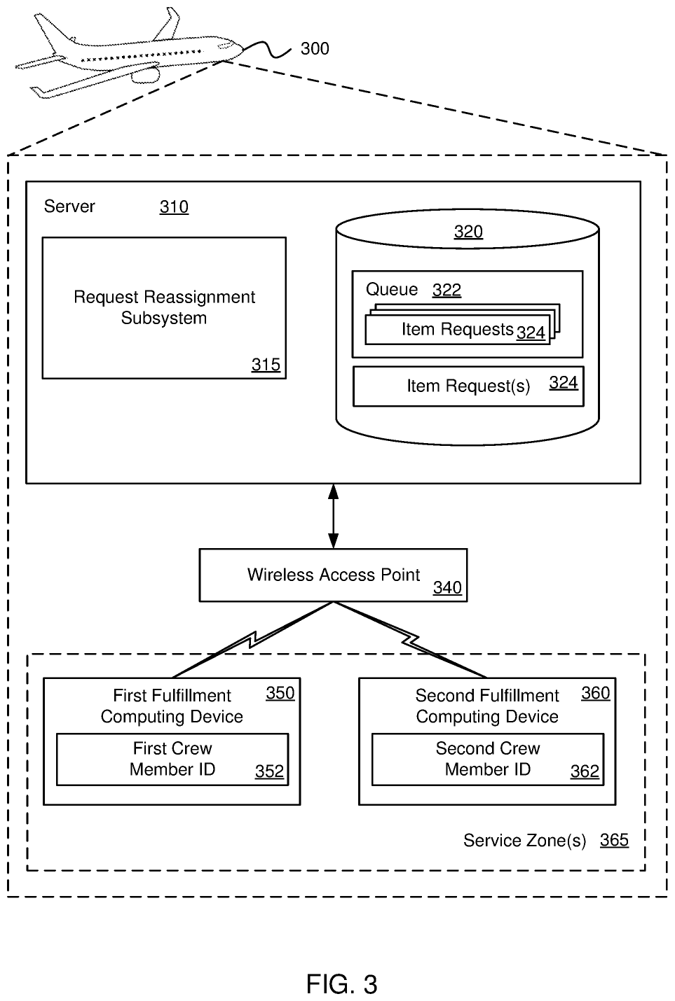

FIG. 3 illustrates an example of a system and related operations for reassigning item request(s) 324 on an aircraft 300. The item request(s) 324 may be reassigned using a request reassignment subsystem 315 that operates on a server 310 onboard the aircraft 300. The server 310 may include all of the functionalities of servers 110, 210, as described earlier. The server 310 may include a data store 320 that maintains a queue 322 of item request(s) 324. The server 310 may receive the item requests 324 from client device(s) located in service zone(s) 365 of the aircraft 300 via a wireless access point 340. The server 310 may assign the received item requests 324 to one of a plurality of fulfillment computing devices that are onboard the aircraft 300, which may include a first fulfillment computing device 350 associated with a first crew member ID 352 and a second fulfillment computing device 360 associated with a second crew member ID 362.

In one example, the request reassignment subsystem 315 may reassign an item request 324 that was initially assigned (or previously assigned) to the first crew member ID 352 associated with the first fulfillment computing device 350 to the second crew member ID 362 associated with the second fulfillment computing device 360 by updating the record of the item request 324. In such a case, the request reassignment subsystem 315 may place the item request 324 back into the queue 322 and then subsequently the request may be transmitted to the second fulfillment computing device 360. In one example, the request reassignment subsystem 315 may receive a request from the first fulfillment computing device 350 indicating that a crew member associated with the first fulfillment computing device 350 is unable to fulfill the item request 324 at a current time. The item request 324 may be unable to be fulfilled for a variety of reasons, such as the crew member being overworked in their particular service zone 365, the crew member being called to attend to an emergency in another service zone 365, the crew member falling ill, etc. In this example, in response to the request received from the first fulfillment computing device 350, the request reassignment subsystem 315 may reassign the item request 324 to the second crew member ID 362 associated with the second fulfillment computing device 360. In one example, the request received from the first fulfillment computing device 350 may identify the second crew member ID 362. In other words, the request may indicate that a crew member associated with the second crew member ID 362 is available to fulfill the item request 324.

In one configuration, the item request 324 may initially be assigned to the first crew member ID 352 associated with the first fulfillment computing device 350. The request reassignment subsystem 315 may detect that the item request 324 has not been fulfilled after a certain period of time. For example, request reassignment subsystem 315 may detect that the item request 324 has not been fulfilled after a period of 10 minutes. In this case, the request reassignment subsystem 315 may automatically reassign the item request 324, for example, to the second crew member ID 362 associated with the second fulfillment computing device 360. In other words, the request reassignment subsystem 315 may automatically reassign the item request 324 when a predetermined amount of time has passed since the item request 324 was assigned to the first crew member ID 352.

In one example, the request reassignment subsystem 315 may reassign item requests 324 for an entire service zone 365 to one or more alternative crew member IDs. For example, the request reassignment subsystem 315 may reassign the item requests 324 for the entire service zone 365 when the item requests 324 are unable to be fulfilled by crew member(s) previously assigned to that service zone 2365. In this case, the request reassignment subsystem 315 may distribute the item requests 324 to other crew member IDs in other service zones 365 of the aircraft 300.

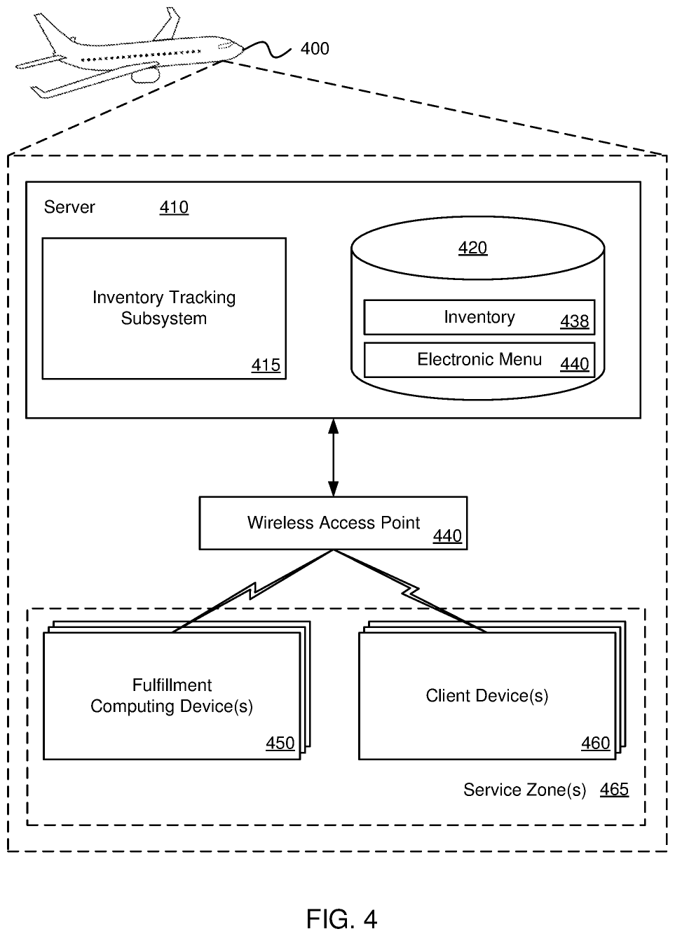

FIG. 4 illustrates an example of a system and related operations for maintaining an inventory 438 of available items on an aircraft 400. The inventory 438 may be a listing of food items, drink items, personal items (e.g., pillows, blankets), etc. that are available for request or purchase on the aircraft 400. The food items may include, but are not limited to, hot meals, sandwiches, snacks, etc. The drink items may include, but are not limited to, water, soda beverages, juice beverages, alcoholic beverages, etc. The personal items may include, but are not limited to, headphones, eye masks, and toiletry or personal hygiene items such as lotions, soaps, etc.

In one example, the inventory 438 may be maintained using an inventory tracking subsystem 415 that operates on a server 410 onboard the aircraft 400. The server 410 may include all of the functionalities of servers 110, 210, 310, as described earlier. The server 410 may include a data store 420 that stores the inventory 438 of available items. In one example, the server 410 may receive item requests from client device(s) 460 located in service zone(s) 465 of the aircraft 400 via a wireless access point 440 and/or wired connection. The server 410 may assign the received item requests to appropriate fulfillment computing device(s) 450 and send the requests to the assigned fulfillment computing device(s) 450 via the wireless access point 440.

In one configuration, the inventory tracking subsystem 415 may maintain the inventory 438 of available items onboard the aircraft 400 based on the item requests received from the client device(s) 460. In other words, the inventory 438 may be automatically maintained or tracked based on the item requests received from the client device(s) 460 and/or the indication of fulfillment of item requests from fulfillment computing devices 450. The inventory 438 may be tracked in real-time to enable passengers to view an update-to-date listing of items that are available for request or purchase on the aircraft 400. The inventory tracking subsystem 415 may detect when a particular item is out of stock or no longer available for request or purchase (e.g., when a particular type of sandwich has run out). The server 410 may maintain an update an electronic menu 440 using the inventory tracking subsystem 415. The electronic menu 440 may be provided in response to requests by the client devices 460. Therefore, passengers on the aircraft 400 may not request or order items off the electronic menu 440 that are no longer available. In addition, the server 410 may send an updated electronic menu 440 to the fulfillment computing devices 450 indicating that the particular item is no longer available to request or purchase.

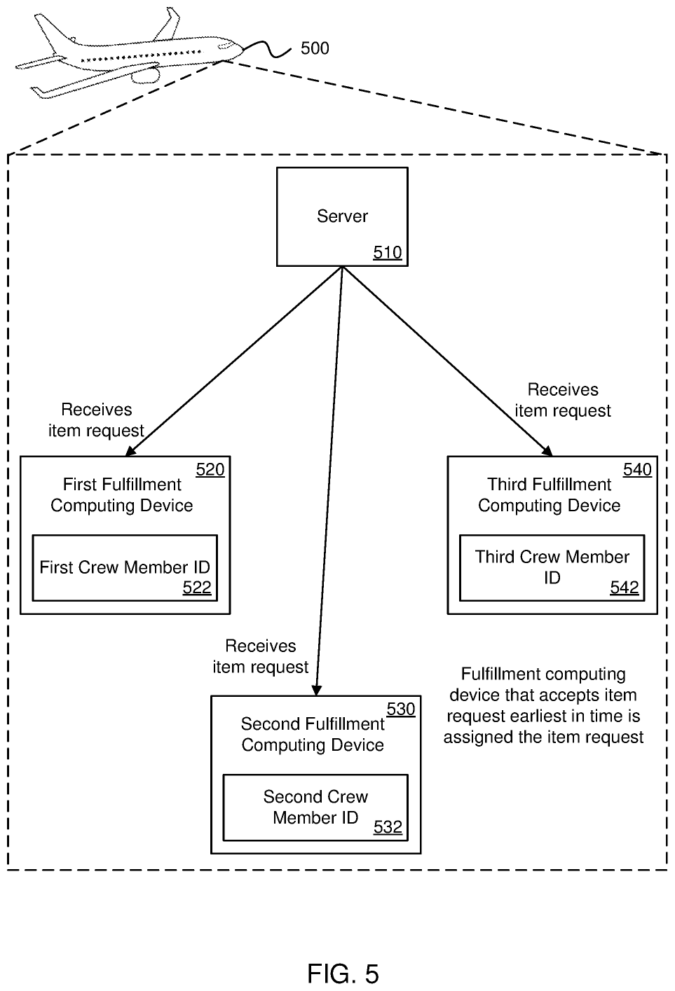

FIG. 5 illustrates an example of a system for assigning item requests on an aircraft 500. A server 510 onboard the aircraft 500 may receive an item request from a client device. The server 510 may include all of the functionalities of servers 110, 210, 310, 410, as described earlier. The server 510 may send the item request to multiple fulfillment computing devices associated with multiple crew member IDs, such as a first fulfillment computing device 520 associated with a first crew member ID 522, a second fulfillment computing device 530 associated with a second crew member ID 532, and a third fulfillment computing device 540 associated with a third crew member ID 542. The server 510 may receive an indication that a particular crew member ID associated with one of the multiple fulfillment computing devices has accepted the item request for fulfillment. In other words, the server 510 may identify an indication that is received earliest in time from among the multiple fulfillment computing devices. The server 510 may assign the item request to the particular crew member ID that accepted the item request. The server 510 may notify a crew member associated with that particular crew member ID that the item request has been assigned to them.

In this example, multiple crew members may be assigned to a service zone, and an item request may be transmitted to each of the multiple crew members. The item request may be assigned to a first crew member that accepts the item request among the multiple crew members.

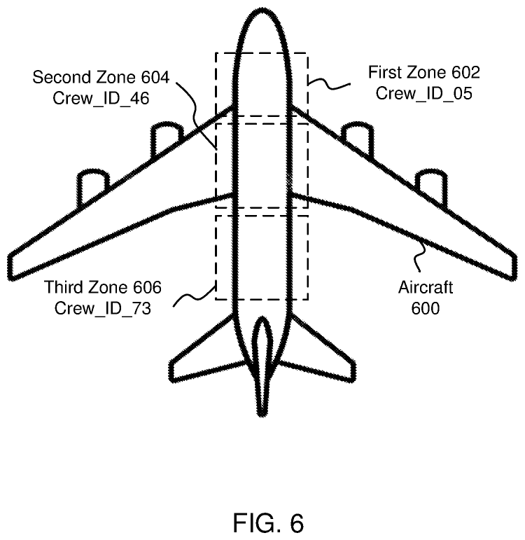

FIG. 6 illustrates an example of a zoning definition for an aircraft 600. The zoning definition may indicate that the aircraft 600 is divided into three separate service zones, which may include a first service zone 602, a second service zone 604 and a third service zone 606. In this example, the first service zone 602 may encompass a front portion of the aircraft 600, the second service zone 604 may encompass a middle portion of the aircraft 600, and the third service zone 606 may encompass a back portion of the aircraft 600. Further, the zoning definition may indicate one or more crew member IDs which are assigned to a particular service zone. For example, the zoning definition may indicate that crew_ID_05 associated with a first crew member may be assigned to the first service zone 602, crew_ID_46 associated with a second crew member may be assigned to the second service zone 604, and crew_ID_73 associated with a third crew member may be assigned to the third service zone 606.

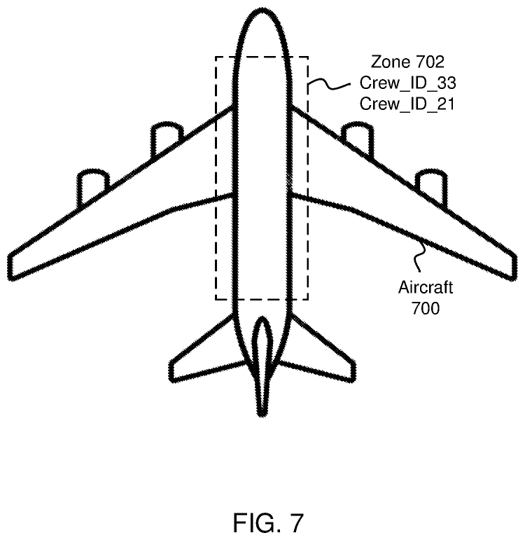

FIG. 7 illustrates an example of a zoning definition for an aircraft 700. The zoning definition may indicate that the aircraft 700 is divided into a single service zone 702. Further, the zoning definition may indicate one or more crew member IDs assigned to the service zone 702. For example, the zoning definition may indicate that crew_ID_33 associated with a first crew member and crew_ID_21 associated with a second crew member may be assigned to the service zone 702. In this example, the service zone 702 may be served by both crew members.

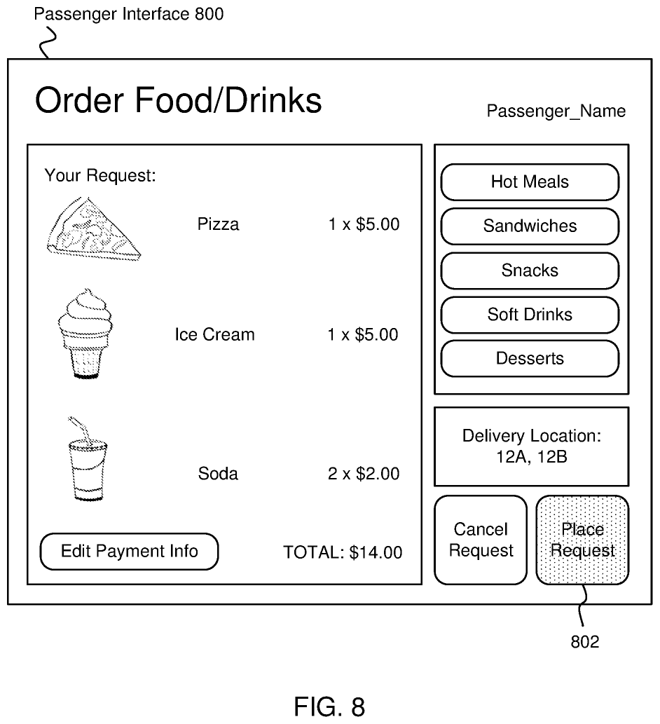

FIG. 8 is an example of a passenger interface 800 for an application that executes on a client device (e.g., a personal electronic device or a seatback system). The passenger interface 800 may allow a passenger to place a request or order for a food and/or drink item while on an aircraft. The passenger interface 800 may allow the passenger to select certain food items and/or drink items, as well as a quantity for each selected item. The passenger may select the items from various categories, such as hot meals, sandwiches, snacks, soft drinks, desserts, etc. The passenger interface 800 may allow the passenger to enter a delivery location. As an example, the passenger may enter his or her seat number. As another example, the passenger may enter multiple seat numbers for the family. As yet another example, the passenger may enter a seat number of a friend on the aircraft. The passenger interface 800 may display a total price for the selected items, and may allow the passenger to enter payment information. When the passenger has finished entering the various portions of the request, the passenger may place the request via a button 802 on the user interface 800.

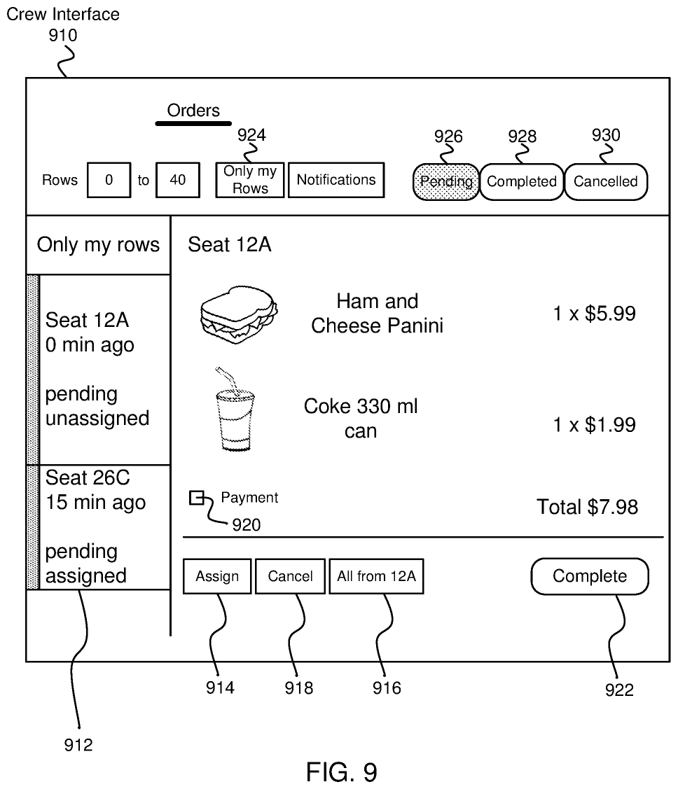

FIG. 9 is an example of a crew interface 910 for an application that executes on a fulfillment computing device. The crew interface 910 may indicate a number of rows of seats (e.g., rows 0 to 40) that are assigned to a crew member having a crew member ID that is associated with the fulfillment computing device. Selecting the “only my rows” button 924 along the top of the crew interface 910 may cause the crew interface 910 to display the rows and corresponding orders for the zone of that fulfillment computing device. The crew interface 910 may provide an option for the crew member to view certain rows (e.g., rows 0 to 40), or alternatively, view any selected rows on an aircraft (e.g., rows 40 through 50). The crew interface 910 may provide an option for the crew member to enter which rows to view at a given time. In other words, in this example, the crew member many manually enter rows 0 to 40 via the crew interface 910.

In one example, the crew interface 910 may provide an option for the crew member to toggle between pending orders 926 (which may include unassigned orders and assigned orders), completed orders 928 and cancelled orders 930. For example, the crew member may separately view the pending orders 926, the completed orders 928 or the cancelled orders 930 for the certain rows and/or all of the rows on the aircraft.

In one example, the crew interface 910 may show a queue of pending orders 912, where the queue is specific to the fulfillment computing device. In other words, the queue of pending orders 912 may include orders that are particular to the crew member ID associated with the fulfillment computing device. In an alternative configuration, many crew members may be using a single fulfillment computing device and items in the queue 912 may be assigned to one of the crew members with a crew member ID using the fulfillment computer device. In the example shown in FIG. 9, the queue of pending orders 912 may include an order for a ham and cheese sandwich and a soft drink, and the order may have a delivery location of seat 12A. Initially, the order corresponding to seat 12A may be unassigned, and the order may be assigned to the crew member via an ‘assign’ button 914 on the crew interface 910. In other words, one crew member using the order fulfillment device may assign the order corresponding to seat 12A via the crew interface 910. In this example, orders may be unassigned because multiple crew members are in the same zone, so the order is initially “unassigned.” The crew member may select the “assign” button 914 in order to accept the order for themselves (i.e., assign the order to themselves). Once the “assign” button 914 is selected, the status of the order may change from “unassigned” to “assigned.”

A second order that is received in the queue 912 may be assigned to a second crew member using the assignment button 914. An assign all button 916 or user interface control may be provided where all the later orders or all subsequent orders may be assigned to a crew member. In addition, a cancel button 918 may be provided to cancel the assignment of the pending order or item.

In one example, after the crew member has physically performed the delivery of the order (e.g., deliver the ham and cheese sandwich and drink to seat 12A) and a payment has been received, the crew member may select a checkbox 920 that the payment has been received, as well as select a “complete” button 922 on the crew interface 910. As an example, the checkbox 920 may be selected once payment is received and the complete button 922 may be selected once the order is delivered, and these actions may be performed at a same time or may be performed one at a time once each activity (e.g., accepting payment, handing the passenger an item) is done. At this point, the order corresponding to seat 12A may be removed from the queue of pending orders, and the order corresponding to seat 12A may be included in the queue of completed orders. As another example, if the crew member cancels the order corresponding to seat 12A using the cancel button 918, the order may be removed from the queue of pending orders, and the order corresponding to seat 12A may be included in the queue of canceled orders. The cancel button 918 may be used to cancel the order if a problem is determined to have occurred with the order or if there is bad information in the order.

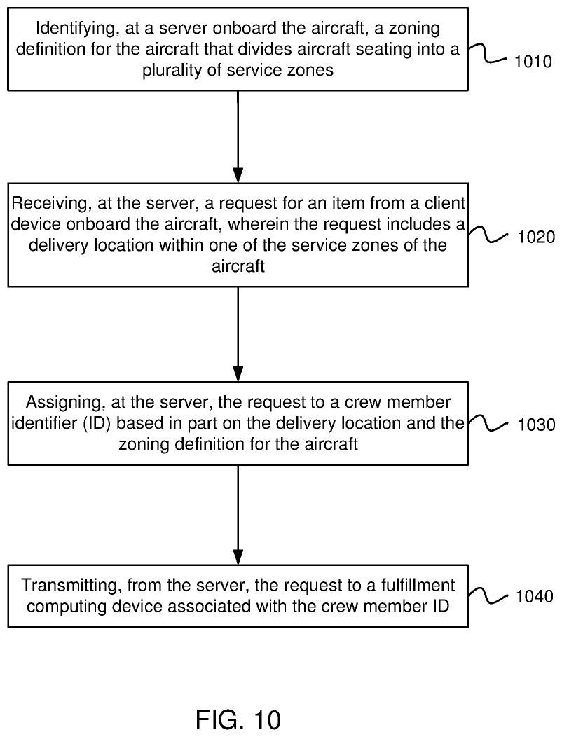

FIG. 10 illustrates an example of a method for processing requested items on an aircraft. A server onboard the aircraft may identify a zoning definition for the aircraft that divides aircraft seating into a plurality of service zones, as in block 1010. For example, the aircraft seating may be divided in the zoning definition for the aircraft based on a number of seating rows on the aircraft, a number of decks on the aircraft, a number of crew members serving the aircraft, a travel class associated with passengers onboard the aircraft, a type of aircraft, a number of passengers onboard the aircraft, and/or a distribution of passengers onboard the aircraft.

The server may receive a request for an item from a client device onboard the aircraft, as in block 1020. The request may indicate a product for a passenger onboard the aircraft, and the request may include a delivery location (e.g., a defined seat) within one of the service zones of the aircraft. In one example, the request may be received from a first application that executes on a client device. The first application may facilitate placing the request via the client device. The client device may be a mobile device within the aircraft, and a connection between the server and the client device may be a wireless connection that is established via a wireless access point onboard the aircraft. Alternatively, the client device may be a seatback system on the aircraft, and a connection between the server and the seatback system may be a wired connection.

The server may assign the request to a crew member identifier (ID) based in part on the delivery location and the zoning definition for the aircraft, as in block 1030. For example, the server may identify the crew member ID associated with a service zone in the plurality of service zones that includes the delivery location in accordance with the zoning definition.

The server may transmit the request to a fulfillment computing device associated with the crew member ID, as in block 1040. The request may be transmitted to a second application that executes on the fulfillment computing device. The second application may facilitate fulfilling the request using the fulfillment computing device. The fulfillment computing device may be a mobile device within the aircraft, and a connection between the server and the fulfillment computing device may be a wireless connection that is established via the wireless access point onboard the aircraft.

In one example, the request may be added to a first-in first-out (FIFO) queue of requests to be fulfilled. A notification may be received from the fulfillment computing device after the request has been fulfilled at the delivery location. In response, the request may be removed from the FIFO queue of requests. In addition, the fulfillment computing device may present the request with a plurality of requests assigned to the fulfillment computing device using the FIFO queue.

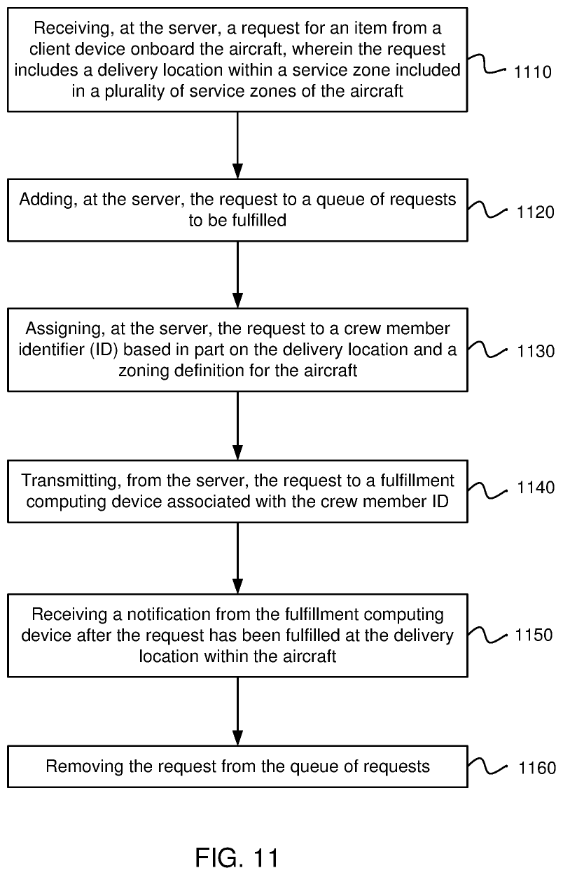

FIG. 11 illustrates an example of a method for processing requested items on an aircraft. A server may receive a request for an item from a client device onboard an aircraft, as in block 1110. The request may include a delivery location in a service zone included in a plurality of service zones of the aircraft. For example, the delivery location may include one or more defined seats on the aircraft.

The server may add the request to a queue of requests to be fulfilled, as in block 1120. The queue may be a list of outstanding or unfulfilled requests received from passengers on the aircraft.

The server may assign the request to a crew member identifier (ID) based in part on the delivery location and a zoning definition for the aircraft, as in block 1130. For example, the server may determine, using the zoning definition, that the crew member ID is assigned to a service zone that includes the delivery location.

The server may transmit the request to a fulfillment computing device associated with the crew member ID, as in block 1140. As a result, a crew member associated with the fulfillment computing device may view the request (e.g., specific item(s) requested or ordered) via a user interface on the fulfillment computing device.

The server may receive a notification from the fulfillment computing device after the request has been fulfilled at the delivery location within the aircraft, as in block 1150. For example, the crew member associated with the fulfillment computing device may fulfill the request (e.g., delivering a requested food or drink item to a passenger at the delivery location), and the crew member may send the notification indicating that the request has been fulfilled via the user interface on the fulfillment computing device. For example, the crew member may check a box, activate a button or engage a user interface (UI) control to send the notification that the request has been completed.

The server may remove the request from the queue of requests, as in block 1160. The server may remove the request from the queue in response to the notification received from the fulfillment computing device indicating that the request has been fulfilled.

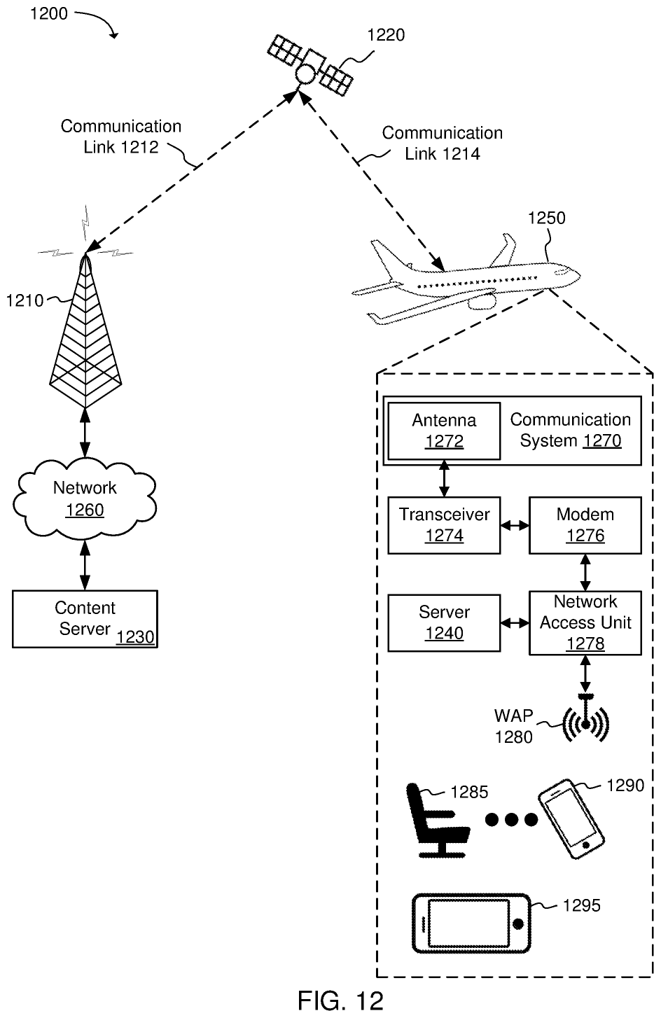

FIG. 12 illustrates an example of a satellite communication system 1200. The satellite communication system 1200 may include satellite(s) 1220 in bidirectional communication with a ground station 1210 via a communication link 1212 between the satellite 1220 and the ground station 1210. The satellite 1220 may also be in bidirectional communication with an aircraft 1250 (e.g., an airplane, helicopter, blimp or balloon) via a communication link 1214 between the satellite 1220 and the aircraft 1250. The communication link 1212 and the communication link 1214 may enable communication between the aircraft 1250 and the ground station 1210 via the satellite 1220 while the aircraft 1250 is stationary or in motion.

In one example, the satellite communication system 1200 may include multiple satellites 1220, where each satellite 1220 may provide coverage for a service area, and service areas for different satellites may be non-overlapping or overlapping. The satellite communication system 1200 may be any suitable type of satellite system, including a geostationary satellite system, medium earth orbit satellite system, low earth orbit satellite system, or combinations thereof. The satellite 1220 may have a number of beams directed at different regions on Earth, where the coverage area of each beam may be non-overlapping or overlapping with one or more other beams. The satellite 1220 may have one or more spot beams covering different regions on Earth within the service area of the satellite 1220. As another example, the satellite 1220 may have one or more wide area coverage beams covering the service area of the satellite 1220. As yet another example, the satellite 1220 may have a combination of spot beams and wide area coverage beams.

In one configuration, the aircraft 1250 may include a communication system 1270 to facilitate bidirectional communication with the satellite 1220 via the communication link 1214. The communication system 1270 may include an antenna 1272 to receive a downlink signal from the satellite 1220 and transmit an uplink signal to the satellite 1220 via the communication link 1214. The aircraft 1250 may include a transceiver 1274 in communication with the antenna 1272, a modem 1276 in communication with the transceiver 1274, a network access unit 1278 (e.g., a router) in communication with the modem 1276, and a wireless access point (WAP) 1280 in communication with the network access unit 1278. Further, the wireless access point 1280 may communicate with one or more client devices in the aircraft 1250, such as seatback systems 1285 and/or client devices 1290 (e.g., mobile phones, tablets, laptops) in the aircraft 1250. Therefore, the communication system 1270 may receive a downlink signal from the satellite 1220 and forward the downlink signal to the client devices, and receive an uplink signal from the client devices and forward the uplink signal to the satellite 1220, thereby supporting two-way data communications between the client devices within the aircraft 1250 and the satellite 1220.

In one configuration, the network access unit 1278 may be in communication with a server 1240 (such as the server 110 described earlier) onboard the aircraft 1250. The server 1240 may identify a zoning definition for the aircraft 1240 that divides aircraft seating into a plurality of service zones. The server 1240 may receive a request for an item from the seatback system 1285 or the client device 1290 onboard the aircraft. The request may include a delivery location within one of the service zones of the aircraft 1250. The server 1240 may assign the request to a crew member identifier (ID) associated with a fulfillment computing device 1295 onboard the aircraft 1250 based in part on the delivery location and the zoning definition for the aircraft 1250. The server 1240 may transmit the request to the fulfillment computing device 1295 associated with the crew member ID.

In one example, the seatback system 1285 may be a fixed or on-aircraft device. The seatback system 1285 may communicate with the server 1240 via a wired communication link. For example, the seatback system 1285 may communicate with the network access unit 1278 over a wired communication link, and the network access unit 1278 may communicate with the server 1240 over a wired communication link. Alternatively, the seatback system 1285 may communicate with the server 1240 via the network access unit 1278 and the wireless access point 1280. The seatback system 1285 may execute one or more applications that provide an interface for users on the aircraft 1250 to obtain and consume data.

In one example, the client device 1290 may receive and display data, and may be brought onto the aircraft 1250 by users (which include passengers or crew members). The client devices 1290 may execute one or more applications that provide the interface for users to obtain and consume data. The user may have the option to select/request data for viewing from the interface. When a user interacts with the client device 1290, the client device 1290 may transmit a request for data to the network access unit 1278 via the wireless access point 1280. The client device 1290 may receive requested data from the network access unit 1278 via the wireless access point 1280. Thus, the wireless access point 1280 may provide communication between the network access unit 1278 and personal electronic device 1290.

In one example, the network access unit 1278 may receive requests for data from the client device 1290 via the wireless access point 1280 and multiplex and forward the requests to the modem 1276. The network access unit 1278 may receive and demultiplex packets associated with the data, and forward the data to the client device 1290 via the wireless access point 1280.

In one example, the modem 1276 may receive requests for data from the network access unit 1278, and the modem 1276 may generate modulated data (e.g., a transmit intermediate frequency (IF) signal) for delivery to the transceiver 1274. Further, the modem 1276 may receive requested data as a modulated data (e.g., a receive intermediate frequency (IF) signal) from the transceiver 1274 and demodulate that data for transmission to the network access unit 1278. In one example, the modem 1276 may be integrated with the network access unit 1278, or alternatively, the modem 1276 and the network access unit 1278 may be separate components.

In one example, the transceiver 1274 may up-convert and amplify modulated data received from the modem 1276 to generate an uplink signal for transmission to the satellite 1220 via the antenna 1272. Similarly, the transceiver 1274 may receive a downlink signal from the satellite 1220 via the antenna 1272. The transceiver 1274 may then amplify and down-convert the downlink signal to generate modulated downlink data (e.g., a receive IF signal) for demodulation by the modem 1276.

In one example, the ground station 1210 may also be referred to as an access node, a hub or a gateway. The ground station 1210 may include an antenna to transmit an uplink signal to the satellite 1220 and receive a downlink signal from the satellite 1220. The ground station 1210 may be in communication with a content server 1230 via a network 1260. The content server 1230 may include electronic advertisements, media content, web content, etc.

In one example, the network 1260 may be any type of network and may include for example, an internet, an internet protocol (IP) network, an intranet, a wide area network (WAN), local area network (LAN), a virtual private network (VPN), a virtual LAN (VLAN), a fiber optic network, a cable network, a public switched telephone network (PSTN), a public switched data network (PSDN), a public land mobile network, a cellular network, and/or any other type of network supporting communication as described herein. The network 1260 may include both wired and wireless connections as well as optical links.

In one example, the ground station 1210 may be provided as an interface between the network 1260 and the satellite 1220. The ground station 1210 may receive data and information directed to the seatback system 1285 and/or the client device 1290 onboard the aircraft 1250 from the content server 1230 accessible via the network 1260. The ground station 1210 may format the data and information and transmit an uplink signal to the satellite 1220 for subsequent delivery to the aircraft 1250 (and then the seatback system 1285 and/or the client device 1290). Similarly, the ground station 1210 may be receive a downlink signal from the satellite 1220 (e.g., containing requests, data and/or information originating from the seatback system 1285 and/or the client device 1290 on the aircraft 1250) that is directed to a destination accessible via the network 1260. The ground station 1210 may format the received downlink signal for transmission on the network 1260.

In one configuration, the seatback system 1285 and/or the client device 1290 may be onboard the aircraft 1250. Alternatively, the seatback system 1285 and/or the client device 1290 may be onboard other types of vehicles, such as trains, automobiles (e.g., cars, trucks, busses, etc.), watercraft (e.g., private boats, commercial shipping vessels, cruise ships, etc.) and others.

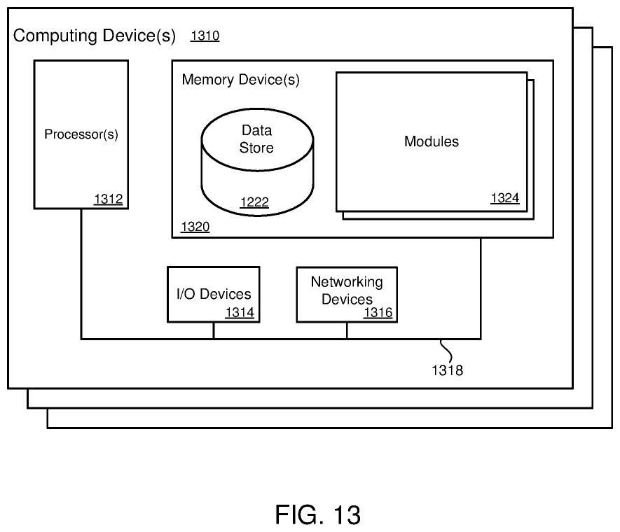

FIG. 13 illustrates a computing device 1310 which may execute the foregoing subsystems of this technology. The computing device 1310 and the components of the computing device 1310 described herein may correspond to the servers, client devices and/or the fulfillment computing devices described above. The computing device 1310 is illustrated on which a high level example of the technology may be executed. The computing device 1310 may include one or more processors 1312 that are in communication with memory devices 1320. The computing device may include a local communication interface 1318 for the components in the computing device. For example, the local communication interface may be a local data bus and/or any related address or control busses as may be desired.

The memory device 1320 may contain modules 1324 that are executable by the processor(s) 1312 and data for the modules 1324. The modules 1324 may execute the functions described earlier. A data store 1322 may also be located in the memory device 1320 for storing data related to the modules 1324 and other applications along with an operating system that is executable by the processor(s) 1312.

Other applications may also be stored in the memory device 1320 and may be executable by the processor(s) 1312. Components or modules discussed in this description that may be implemented in the form of software using high programming level languages that are compiled, interpreted or executed using a hybrid of the methods.

The computing device may also have access to I/O (input/output) devices 1314 that are usable by the computing devices. An example of an I/O device is a display screen that is available to display output from the computing devices. Other known I/O device may be used with the computing device as desired. Networking devices 1316 and similar communication devices may be included in the computing device. The networking devices 1316 may be wired or wireless networking devices that connect to the internet, a LAN, WAN, or other computing network.

The components or modules that are shown as being stored in the memory device 1320 may be executed by the processor 1312. The term “executable” may mean a program file that is in a form that may be executed by a processor 1312. For example, a program in a higher level language may be compiled into machine code in a format that may be loaded into a random access portion of the memory device 1320 and executed by the processor 1312, or source code may be loaded by another executable program and interpreted to generate instructions in a random access portion of the memory to be executed by a processor. The executable program may be stored in any portion or component of the memory device 1320. For example, the memory device 1320 may be random access memory (RAM), read only memory (ROM), flash memory, a solid state drive, memory card, a hard drive, optical disk, floppy disk, magnetic tape, or any other memory components.

The processor 1312 may represent multiple processors and the memory 1320 may represent multiple memory units that operate in parallel to the processing circuits. This may provide parallel processing channels for the processes and data in the system. The local interface 1318 may be used as a network to facilitate communication between any of the multiple processors and multiple memories. The local interface 1318 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom Very Large Scale Integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, electrically erasable programmable read-only memory (EEPROM), flash memory or other memory technology, compact disc read-only memory (CD-ROM), digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

In describing the present technology, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes and other characteristics need not be exact, but can be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations including, for example, tolerances, measurement error, measurement accuracy limitations and other factors known to those of skill in the art, can occur in amounts that do not preclude the effect the characteristic was intended to provide. Numerical data can be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited.

As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3 and 4 and sub-ranges such as 1-3, 2-4 and 3-5, etc. This same principle applies to ranges reciting only one numerical value (e.g., “greater than about 1”) and should apply regardless of the breadth of the range or the characteristics being described. A plurality of items can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Furthermore, where the terms “and” and “or” are used in conjunction with a list of items, they are to be interpreted broadly, in that any one or more of the listed items can be used alone or in combination with other listed items. The term “alternatively” refers to selection of one of two or more alternatives, and is not intended to limit the selection to only those listed alternatives or to only one of the listed alternatives at a time, unless the context clearly indicates otherwise. The term “coupled” as used herein does not require that the components be directly connected to each other. Instead, the term is intended to also include configurations with indirect connections where one or more other components can be included between coupled components. For example, such other components can include amplifiers, attenuators, isolators, directional couplers, redundancy switches, and the like. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples. As used herein, a “set” of elements is intended to mean “one or more” of those elements, except where the set is explicitly required to have more than one or explicitly permitted to be a null set.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for processing requested items on an aircraft, comprising:
identifying, at a server onboard the aircraft, a zoning definition for the aircraft that divides aircraft seating into a plurality of service zones;
receiving, at the server, a request for an item from a client device onboard the aircraft, wherein the request includes a delivery location within one of the service zones of the aircraft;
assigning, at the server, the request to a crew member identifier (ID) based in part on the delivery location and the zoning definition for the aircraft; and
transmitting, from the server, the request to a fulfillment computing device associated with the crew member ID.

2. The method of claim 1, wherein:
the request is received from a first application that executes on the client device; and
the request is transmitted to a second application that executes on the fulfillment computing device,
wherein the first application facilitates placing the request via the client device and the second application facilitates fulfilling the request using the fulfillment computing device.

3. The method of claim 1, further comprising:
adding the request to a first-in first-out (FIFO) queue of requests to be fulfilled;
assign the request to the crew member ID; and
removing the request from the FIFO queue of requests.

4. The method of claim 1, wherein the aircraft seating is divided in the zoning definition for the aircraft based on at least one of: a number of seating rows on the aircraft, a number of decks on the aircraft, a number of crew members serving the aircraft, a travel class associated with passengers onboard the aircraft, a type of aircraft, a number of passengers onboard the aircraft, or a distribution of passengers onboard the aircraft.

5. The method of claim 1, wherein the fulfillment computing device is a first fulfillment computing device, and further comprising:
reassigning the request to a second crew member ID associated with a second fulfillment computing device by transmitting the request to the second fulfillment computing device.

6. The method of claim 5, wherein the reassigning of the request is in response to a request received from the first fulfillment computing device.

7. The method of claim 6, wherein the request for reassigning from the first fulfillment computing device identifies the second fulfillment computing device.

8. The method of claim 1, further comprising:
maintaining an inventory of available items onboard the aircraft based in part on requests received at the server from client devices, wherein the inventory is automatically maintained at the server based on the requests; and
sending an indication to the client devices when an item is no longer available to request, as indicated by the inventory of available items onboard the aircraft.

9. The method of claim 1, further comprising notifying crew members of locations on the aircraft that include the available items.

10. The method of claim 1, wherein:
the transmitting further comprises transmitting the request to multiple fulfillment computing devices associated with multiple crew member IDs including the crew member ID, wherein each of the multiple crew member IDs are associated with the one of the service zones; and
further comprising receiving an indication that the crew member ID associated with one of the multiple fulfillment computing devices has accepted the request for fulfillment, wherein the assigning of the request is to the crew member ID in response to the receiving the indication.

11. The method of claim 1, further comprising presenting, at the fulfillment computing device, the request among a plurality of requests assigned to the fulfillment computing device using a first-in first-out (FIFO) queue.

12. The method of claim 1, wherein the request indicates a product for a passenger onboard the aircraft, and the delivery location includes a defined seat on the aircraft.

13. The method of claim 1, wherein the client device and the fulfillment computing device are mobile devices within the aircraft, and a connection between the server and the client device and the fulfillment computing device are wireless connections that are established via a wireless access point onboard the aircraft.

14. The method of claim 1, wherein the client device is a seatback system on the aircraft, and a connection between the server and the seatback system is a wired connection.

15. A non-transitory machine readable storage medium having instructions embodied thereon, the instructions when executed by one or more processors, cause the one or more processors to perform a process comprising:
receiving, at a server, a request for an item from a client device onboard an aircraft, wherein the request includes a delivery location in a service zone included in a plurality of service zones of the aircraft;
adding, at the server, the request to a first-in first-out queue of requests to be fulfilled;
assigning, at the server, the request to a crew member identifier (ID) based in part on the delivery location and a zoning definition for the aircraft;
transmitting, from the server, the request to a fulfillment computing device associated with the crew member ID;
removing, at the server, the request from the the first-in first-out queue of requests after the request is assigned to the crew member ID; and
receiving a notification from the fulfillment computing device after the request has been fulfilled at the delivery location within the aircraft.

16. The non-transitory machine readable storage medium of claim 15, further comprising instructions when executed by the one or more processors, cause the one or more processors to perform the process including:
identifying the zoning definition for the aircraft that divides the aircraft into the plurality of service zones based on at least one of: a number of seating rows on the aircraft, a number of decks on the aircraft, a number of crew members serving the aircraft, a travel class associated with passengers onboard the aircraft, a type of aircraft, a number of passengers onboard the aircraft, or a distribution of passengers onboard the aircraft.

17. The non-transitory machine readable storage medium of claim 15, wherein:
the request is received from a first application that executes on the client device; and
the request is transmitted to a second application that executes on the fulfillment computing device,
wherein the first application facilitates submitting the request via the client device and the second application facilitates fulfilling the request using the fulfillment computing device.

18. The non-transitory machine readable storage medium of claim 15, wherein the fulfillment computing device is a first fulfillment computing device, and further comprising instructions when executed by the one or more processors, cause the one or more processors to perform the process including:
reassigning the request to a second crew member ID associated with a second fulfillment computing device by transmitting the request to the second fulfillment computing device.

19. The non-transitory machine readable storage medium of claim 18, wherein the reassigning of the request is in response to a request received from the first fulfillment computing device.

20. The non-transitory machine readable storage medium of claim 18, wherein the request for reassigning from the first fulfillment computing device identifies the second fulfillment computing device.

21. The non-transitory machine readable storage medium of claim 15, further comprising instructions when executed by the one or more processors, cause the one or more processors to perform the process including:
maintaining an inventory of available items onboard the aircraft based in part on requests received at the server from client devices, wherein the inventory is automatically maintained at the server based on the requests; and
sending an indication to the client devices when an item is no longer available to request, as indicated by the inventory of available items onboard the aircraft.

22. The non-transitory machine readable storage medium of any claim 15, further comprising instructions when executed by the one or more processors, cause the one or more processors to perform the process including: notifying crew members of locations on the aircraft that include available items.

23. The non-transitory machine readable storage medium of claim 15, wherein:
the transmitting further comprises transmitting the request to multiple fulfillment computing devices associated with multiple crew member IDs, wherein each of the multiple crew member IDs are associated with one of the service zones; and
further comprising instructions when executed by the one or more processors, cause the one or more processors to perform the process comprising: receiving an indication that a crew member ID associated with one of the multiple fulfillment computing devices has accepted the request for fulfillment, wherein the assigning of the request is to the crew member ID.

24. The non-transitory machine readable storage medium of claim 15, further comprising instructions when executed by the one or more processors, cause the one or more processors to perform the process comprising: receiving payment information for the request from the client device.

25. The non-transitory machine readable storage medium of claim 15, wherein the request indicates a product for a passenger onboard the aircraft, and the delivery location includes a defined seat on the aircraft.

26. The non-transitory machine readable storage medium of claim 15, wherein the client device and the fulfillment computing device are mobile devices within the aircraft, and a connection between the server and the client device and the fulfillment computing device are wireless connections that are established via a wireless access point onboard the aircraft.

27. The non-transitory machine readable storage medium of claim 15, wherein the client device is a seatback system on the aircraft, and a connection between the server and the seatback system is a wired connection.

28. A system, comprising:
at least one processor;
at least one memory device including a data store to store a plurality of data and instructions that, when executed, cause the system to:
identify a zoning definition for an aircraft that divides aircraft seating into a plurality of service zones, wherein the zoning definition assigns one or more crew member identifiers (IDs) to each of the service zones;
receive a request for an item from a first application that executes on a client device, wherein the request includes a delivery location within one of the service zones of the aircraft;
identify a crew member ID associated with a service zone in the plurality of service zones that includes the delivery location in accordance with the zoning definition; and
transmit the request to a second application that executes on a fulfillment computing device associated with the crew member ID.

29. The system of claim 28, wherein the first application facilitates submitting the request via the client device and the second application facilitates fulfilling the request using the fulfillment computing device.

30. The system of claim 28, wherein the plurality of data and instructions, when executed, cause the system to:
add the request to a queue of requests to be fulfilled; and
remove the request from the queue of requests after the crew member ID is identified and the request is assigned to the crew member ID.

31. The system of claim 28, wherein the aircraft seating is divided in the zoning definition for the aircraft based on at least one of: a number of seating rows on the aircraft, a number of decks on the aircraft, a number of crew members serving the aircraft, a travel class associated with passengers onboard the aircraft, a type of aircraft, a number of passengers onboard the aircraft, or a distribution of passengers onboard the aircraft.

32. The system of claim 28, wherein the fulfillment computing device is a first fulfillment computing device, and wherein the plurality of data and instructions, when executed, cause the system to:
reassign the request to a second crew member ID associated with a second fulfillment computing device by transmitting the request to the second fulfillment computing device.

33. The system of claim 32, wherein the reassigning of the request is in response to a request received from the first fulfillment computing device.

34. The system of claim 32, wherein the request for reassigning from the first fulfillment computing device identifies the second fulfillment computing device.

35. The system of claim 28, wherein the plurality of data and instructions, when executed, cause the system to:
maintain an inventory of available items onboard the aircraft based in part on requests received at a server from client devices, wherein the inventory is automatically maintained at the server based on the requests; and
send an indication to the client devices when an item is no longer available to request, as indicated by the inventory of available items onboard the aircraft.

36. The system of claim 28, wherein the plurality of data and instructions, when executed, cause the system to: notify crew members of locations on the aircraft that include available items.

37. The system of claim 28, wherein the plurality of data and instructions, when executed, cause the system to:
transmit the request to multiple fulfillment computing devices associated with multiple crew member IDs including the crew member ID, wherein each of the multiple crew member IDs are associated with the one of the service zones; and
receive an indication that the crew member ID associated with one of the multiple fulfillment computing devices has accepted the request for fulfillment, wherein the assigning of the request is to the crew member ID in response to the receiving the indication.

38. The system of claim 28, wherein the request indicates a product for a passenger onboard the aircraft, and the delivery location includes a defined seat on the aircraft.

39. The system of claim 28, wherein the client device and the fulfillment computing device are mobile devices within the aircraft, and a connection between a server and the client device and the fulfillment computing device are wireless connections that are established via a wireless access point onboard the aircraft.

40. The system of claim 28, wherein the client device is a seatback system on the aircraft, and a connection between a server and the seatback system is a wired connection.
